(19) United States
(12) Patent Application Publication
(10) Pub. No.: US 2019/0239290 A1
(43) Pub. Date: Aug. 1, 2019

(54) TOWEL WITH INTEGRAL HEATING MECHANISM

(71) Applicant: Michalyn Demaris Porter, Missouri City, TX (US)

(72) Inventor: Michalyn Demaris Porter, Missouri City, TX (US)

(21) Appl. No.: 16/380,460

(22) Filed: Apr. 10, 2019

Related U.S. Application Data
(60) Provisional application No. 62/655,439, filed on Apr. 10, 2018.

(51) Int. Cl. H05B 3/34; A47K 10/02; H05B 1/02

(52) U.S. Cl. CPC H05B 3/342; H05B 1/0272; A47K 10/02

(57) ABSTRACT

A towel with an integral heating mechanism. The towel includes a pair of opposing fabric members with a heating element therebetween. The pair of opposing fabric members defines a perimeter. The pair of opposing fabric members are attached at the perimeter each thereof. An inner cavity is formed between the pair of opposing fabric members. The heating element is disposed in the inner cavity. The heating element is enclosed in a pair of internal waterproof layers. An actuator is operably connected with the heating element.

### CROSS REFERENCE TO RELATED APPLICATIONS

This application claims the benefit of U.S. Provisional Application No. 62/655,439 filed on Apr. 10, 2018. The above identified patent application is herein incorporated by reference in its entirety to provide continuity of disclosure.

### BACKGROUND OF THE INVENTION

The present invention relates to heated towels. Most individuals use towels to dry off after bathing or showering. However, after exiting a hot shower or bath, the user s frequently uncomfortably cold, as the relative temperature difference between the warmer area in the shower or bath and the colder area surrounding the shower or bath is significant. Traditional towels typically do not provide additional warmth to a user while the user is drying off.

Additionally, warm compresses are frequently used to treat individuals suffering with a fever, as heat is more readily transferred away from damp skin. This generally entails heating water to soak into a towel. However, this process is often time consuming as water can take a while to heat up. Additionally, the water absorbed into the warm compress rapidly cools, leaving the user with a cold damp towel, which can be uncomfortable.

Over the years, many variations of heated articles have been invented and manufactured. Traditionally, these heated articles comprise a blanket having a heating element disposed within waterproof materials, such that the user can activate the heating element to heat the blanket to a desired temperature. Alternative devices teach a heating apparatus configured to heat a towel prior to use, such that the user is provided a towel at a desired temperature. These devices allow a user to comfortably dry off after a bath or shower, or alternatively use the heated towel to provide concentrated heat to an area of the body, such as a compress on the forehead, or around a limb to treat sore muscles. These devices, however, fail to disclose a towel that can be heated and includes absorbent materials on an outer layer thereof, such that a user can dry themselves.

### SUMMARY OF THE INVENTION

In view of the foregoing disadvantages inherent in the known types of heated towels, the present invention provides a heating towel with a integrated heating element wherein the same can be utilized for providing convenience to the user when using a towel to become dry.

The present invention provides an improved heated towel apparatus. The device comprises a towel having an internal heating mechanism, wherein the towel includes a pair of opposing fabric members. The pair of opposing fabric members comprise an absorbent material. A heating element is disposed between the pair of opposing fabric members, wherein the heating element is enclosed by internal waterproof layers. The heating element comprises a waterproof rechargeable battery operably connected to one or more resistive heating wires via a waterproof electrical connector. The rechargeable battery is disposed within a pocket disposed on one of the pair of opposing fabric members, wherein the pocket is configured to allow easy access to the rechargeable battery. The resistive heating wires are disposed in a snaking pattern across the length of the towel, such that the resistive heating wires are configured to heat an entire area of the towel evenly.

The towel with integral heating mechanism is suitable for several uses. For example, the towel with integral heating mechanism can be used for relaxation at a spa or a salon. Additionally, the towel with integral heating mechanism may be placed over the face of the user and left for a predetermined amount of time, such as for relaxation or to prepare facial hair for shaving. Many individuals find that a mixture of heat and moisture provides relaxation as dead skin cells, dirt and debris are removed from their skin. Furthermore, the towel with integral heating mechanism provides convenience to the user when utilized for hair treatments such as deep-conditioning treatments or hot oil treatments. Heat produced by the towel with integral heating mechanism infiltrates the hair's follicles, increasing the effectiveness of the aforementioned treatments.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the towel with integral heating mechanism.

FIG. 2 shows an exploded view of an embodiment of the towel with integral heating mechanism.

### DETAILED DESCRIPTION OF THE INVENTION

Reference is made herein to the attached drawings. Like reference numerals are used throughout the drawings to depict like or similar elements of the towel with integrated heating element. The figures are intended for representative purposes only and should not be considered to be limiting in any respect.

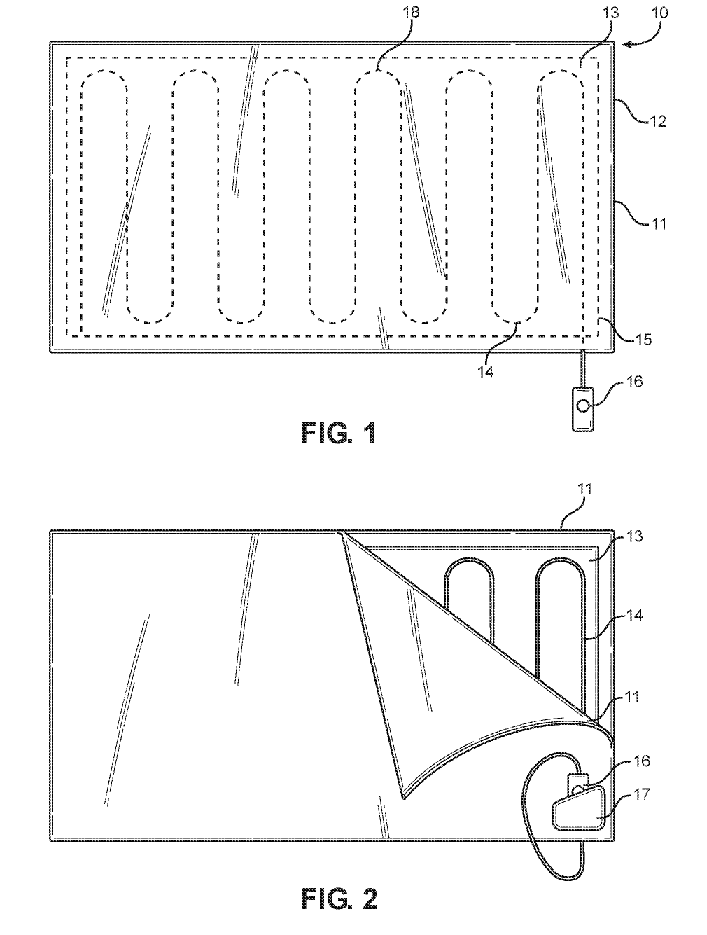

Referring now to FIG. 1, there is shown a perspective view of an embodiment of the towel with integral heating mechanism. The towel with integral heating mechanism 10 comprises a pair of opposing fabric members 11. Each opposing fabric member of the pair of opposing fabric members 11 defines a perimeter 12. Each opposing fabric member of the pair of opposing fabric members 11 is attached to the other opposing fabric member at the perimeter 12 thereof. In one embodiment, each opposing fabric member of the pair of opposing fabric members 11 is attached to the other fabric member of the pair of opposing fabric members 11 via a thread.

The pair of opposing fabric members 11 are made of any suitable material for the contemplated purpose. In one embodiment, the pair of opposing fabric members 11 are made of an absorbent material. As such, the opposing fabric members 11 will provide increased comfort for the user when the invention is utilized as a towel. Furthermore, when the pair of opposing fabric members 11 are made of an absorbent material, the effectiveness of the invention as a towel is increased. In one embodiment, the pair of opposing fabric members 11 are made of terry cloth.

The perimeter 12 of the pair of opposing fabric members 11 is of any shape to meet a specific need or desire of the user. In the illustrated embodiment, the perimeter 12 of the pair of opposing fabric members 11 defines a rectangular configuration, such that the towel with integral heating mechanism 10 can be utilized as a traditional towel. In alternate embodiment, the perimeter 12 is of a circular configuration.

An inner cavity 13 is defined between the pair of opposing fabric members 11. A heating element 14 is disposed within the inner cavity 13. The heating element 14 is enclosed in a pair of internal waterproof layers 15. As such, the heating element 14 can be electrically powered without the risk of water damage as water is absorbed by the pair of opposing fabric members 11. Additionally, the pair of internal waterproof layers 15 provide safety from electrical shock to the user.

In one embodiment, the heating element 14 comprises a power source in operable connection with one or more resistive heating wires 18. In the illustrated embodiment, the plurality of resistive heating wires 18 is disposed in the inner cavity in a snaking pattern. By utilizing a snaking pattern, heat is more evenly provided throughout the area of the towel with integral heating mechanism 10. Alternative patterns for the plurality of resistive heating wires 18 are contemplated. In the illustrated embodiment, the plurality of resistive heating wires 18 utilizes a single circuit.

An actuator 16 is in operable connection with the heating element 14. As such, the heating element 14 can be activated and deactivated via actuation of the actuator 16. In the illustrated embodiment, the actuator 16 is a remote control having a button thereon. The button is configured to activate the heating element 14 when pressed while the heating element 14 is deactivated and to deactivate the heating element 14 when pressed while the heating element 14 is activated. In an alternate embodiment, the actuator 16 provides a display upon which the user can select a desired temperature.

Referring now to FIG. 2, there is shown an exploded view of an embodiment of the towel with integral heating mechanism. The power source is connected to the heating element via an electrical connection. In one embodiment, the power source is a battery. In a further embodiment, the power source is a rechargeable battery. In the illustrated embodiment, the rechargeable battery is disposed within a pocket 17. The pocket 17 is disposed upon an external surface of the pair of opposing fabric members 11. In the illustrated embodiment, the rechargeable battery is integrated upon the actuator 16. As such the actuator 16 itself is storable in the pocket 17. In a further embodiment, the pocket 17 comprises a waterproof lining and a fastener, such that the pocket 17 is waterproof.

In use, the user actuates the heating element via the actuator 16. Over time, the heating element increases the temperature of the inner cavity, thus warming the pair of opposing fabric members. As such, the warmth of the heating element combined with the soft texture of the pair of opposing fabric members will provide warmth and comfort to the user. Additionally, the internal waterproof layers in which the heating element is disposed prevent water from entering into the heating element causing electrical damage. Additionally, the user can wrap the pair of opposing fabric members around a specific body part, such that the user can use the towel with integral heating element to relax a specific muscle, relieve a fever, or otherwise warm his or her body.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A towel with integral heating mechanism, comprising:
a pair of opposing fabric members, each defining a perimeter;
the pair of opposing fabric members attached at the perimeters of each thereof, thereby forming an inner cavity therebetween;
a heating element disposed in the inner cavity;
the heating element enclosed in a pair of internal waterproof layers;
an actuator operably connected with the heating element.

2) The towel of claim 1, wherein the pair of opposing fabric members are made of an absorbent material.

3) The towel of claim 1, wherein the pair of opposing fabric members are made of terry cloth.

4) The towel of claim 1, wherein the heating element comprises a power source in operable connection with one or more resistive heating wires.

5) The towel of claim 4, wherein the power source is a battery.

6) The towel of claim 4, wherein the power source is a rechargeable battery.

7) The towel of claim 6, wherein the rechargeable battery is disposed within a pocket.

8) The towel of claim 7, wherein the pocket is disposed on an external surface of one fabric member of the pair of opposing fabric members.

9) The towel of claim 1, wherein the heating element is disposed in the inner cavity in a snaking pattern.

10) The towel of claim 7, wherein the pocket further comprises a waterproof liner and a fastener.

11) A towel with integral heating mechanism, comprising:
a pair of opposing fabric members, each defining a perimeter;
the pair of opposing fabric members attached at the perimeters of each thereof, thereby forming an inner cavity therebetween;
the pair of opposing fabric members defining a rectangular shape;
a heating element disposed in the inner cavity;
the heating element enclosed in a pair of internal waterproof layers;
an actuator operably connected with the heating element via a cable;
the pair of internal waterproof layers being of a lesser perimeter than the pair of opposing fabric members.
